(19) United States
(12) Patent Application Publication
(10) Pub. No.: US 2015/0205594 A1
(43) Pub. Date: Jul. 23, 2015

(54) DELIVERY AND UPDATING OF EXTENSIONS TO SOFTWARE PRODUCTS

(71) Applicant: ADOBE SYSTEMS INCORPORATED, SAN JOSE, CA (US)

(72) Inventors: Boris Pruessmann, Hamburg (DE); Frank Soetebeer, Amelinghausen (DE); Daniel C. Brotsky, Berkeley, CA (US)

(73) Assignee: ADOBE SYSTEMS INCORPORATED, San Jose, CA (US)

(21) Appl. No.: 12/140,953

(22) Filed: Jun. 17, 2008

Related U.S. Application Data
(60) Provisional application No. 61/049,370, filed on Apr. 30, 2008.

(51) Int. Cl. G06F 9/445; H04L 29/08

(52) U.S. Cl. CPC G06F 8/65; H04L 67/10

(57) ABSTRACT

Methods, systems, and apparatus, including computer program products, for delivering and/or updating extensions to software products. One or more extensions from a source external to a client computer can be retrieved to a client computer. Each extension includes software configured to integrate with one or more software products installed on the client computer and a user interface to extend user interaction within one or more software products. Each extension can be distributed to the one or more software products. Updates corresponding to the extensions are automatically retrieved and distributed to one or more compatible software products. In other aspects, version information for one or more extensions hosted by one or more software products installed on the client computer can be determined. Based on the version information, updates available for the extensions can be obtained and distributed to the software products compatible with the corresponding extensions.

### CROSS-REFERENCE TO RELATED APPLICATIONS

This application claims priority to pending U.S. Provisional Patent Application Ser. No. 61/049,370, filed on Apr. 30, 2008, the entire contents of which are incorporated herein by reference.

### TECHNICAL FIELD

The present disclosure relates to extensions for software products.

### BACKGROUND

A software product executing locally on a client computer may integrate with a network service (e.g., a web service) to provide one or more additional features. For example, a web service available over the Internet may be integrated with a software product installed on a client computer having Internet connectivity. In these circumstances, the web service is generally referred to as a “hosted service” or an “extension”. The software product may ship with the extension including a user interface that can be used to interface with the extension through the software product. Typically, for user-interactive extensions having a user interface to extend user interaction within the host software product, updates to the extension are only possible by updating the software product, and additional extension functionally can only be exposed after the software product update.

### SUMMARY

This specification describes technologies relating to extensions to software products. In general, one aspect of the subject matter described in this specification can be embodied in methods that include retrieving to a client computer over a network one or more extensions from a source external to the client computer. Each extension includes software that is configured to integrate with one or more software products installed on the client computer and includes a user interface to extend user interaction within the one or more software products. Each extension is distributed to the one or more software products on the client computer. Updates corresponding to the one or more extensions are automatically retrieved over the network and distributed to the one or more software products executing on the client computer compatible with the corresponding extension.

Other embodiments of this aspect include corresponding systems, apparatus, and computer program products. These and other embodiments can optionally include one or more of the following features. Retrieving over the network the one or more extensions can be in response to a user input subscribing to the one or more extensions. At least one of the one or more extensions can include software requiring a network connection to execute full functionality on the client computer. At least one of the one or more extensions can include software executable on the client computer without a network connection. At least one of the one or more extensions can include software executable on the client computer without a network connection to provide partial functionality and with a network connection to provide full functionality.

Automatically retrieving over the network updates corresponding to the one or more extensions can include determining version information for each of the one or more extensions retrieved, providing the version information over the network to an extension service, and receiving the updates from the extension service over the network. The method can further include periodically determining whether an update for each of the one or more extensions exists. Automatically retrieving over the network updates corresponding to the one or more extensions can be in response to determining an update for each of the one or more extensions exists.

In general, one aspect of the subject matter described in this specification can be embodied in methods including determining version information for one or more extensions hosted by one or more software products installed on a client computer. Version information specifies a version of the extension. Each extension includes software that is configured to integrate with the one or more host software products and includes a user interface to extend user interaction within the one or more software products. Based on the version information, updates available for the one or more extensions are obtained and distributed to the one or more software products compatible with the corresponding extensions.

Other embodiments of this aspect include corresponding systems, apparatus, and computer program products. These and other embodiments can optionally include one or more of the following features. The method can further include providing the version information over the network to an extension service and obtaining the updates from the extension service over the network. In another implementation, the method can further include periodically determining if updates are available, wherein obtaining updates is in response to determining that updates are available.

In general, one aspect of the subject matter described in this specification can be embodied in a system including a client computer and a server. The client computer includes one or more software products installed on the client computer, an extension manager and one or more extensions. The extension manager is configured to retrieve the one or more extensions over a network and to distribute the one or more extensions to one or more of the software products compatible with the extensions. The extension manager is further configured to automatically retrieve updates to the one or more extensions over a network and to distribute the updates to the one or more software products compatible with the extensions corresponding to the updates. Each extension includes software that is configured to integrate with the one or more compatible software products and includes a user interface to extend user interaction within the one or more compatible software products. The server includes an extension service configured to provide information to the extension manager, based on which the extension manager can retrieve the one or more extensions and the updates to the one or more extensions.

Optionally, embodiments can include one or more of the following features. The server can further include an update cache including information based on which the extension manager can retrieve the updates to the one or more extensions. The server can further include a subscription service configured to receive input from a user of the client computer subscribing to the one more extensions. In response to the received input, the information based on which the extension manager can retrieve the one or more extensions can be provided to the extension manager. In some implementations, the “server” can be implemented with two more services, for example, the subscription service, update cache and/or extension service can be resident on different servers, where the two or more servers together are referred to as the “server”.

Particular embodiments of the subject matter described in this specification can be implemented to realize one or more of the following advantages. An extension integrated with a software product installed on a client computer can be updated separate from the software product. Updates can be applied periodically to keep the extension current, whether or not the host software product has been updated. A user can subscribe to an extension, or a bundle of extensions. The extensions are then automatically uploaded to the user's client computer and distributed to compatible software products installed on the client computer. Updates for the extensions subscribed to by the user are automatically periodically sought, retrieved and distributed to the corresponding software products on the client computer.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is schematic representation of an example system for delivering and updating extensions to software products.

FIG. 2 is a flowchart showing an example method for delivering and updating extensions to software products.

FIG. 3 is a data flow diagram showing an example data flow for delivering and updating extensions to software products.

Like reference numbers and designations in the various drawings indicate like elements.

### DETAILED DESCRIPTION

Techniques, computer programs and systems are described to deliver and update extensions to a software product. An “extension” is a software application deliverable over a network and is configured to integrate with one or more software products executing on a client computer. More particularly, as used herein, extension refers to an extension that provides a user interface to integrate with a host software product and extends user interaction within the software product. By way of illustrative example, Adobe® kuler (“Kuler”) is a web-hosted application from Adobe Labs of Adobe Systems Incorporated, San Jose, Calif., for generating color themes. Kuler is an extension compatible with several software products including, for example, Adobe Illustrator®, Adobe InDesign® and Adobe Photoshop®.

The extension (e.g., Kuler) can be retrieved from a source external to a client computer, for example, delivered over a network connection or shipped with a software product (e.g., as a plug-in). The extension is distributed to one or more software products (e.g., Illustrator, InDesign or Photoshop) executing on the client computer compatible with the extension. Updates corresponding to the one or more extensions are automatically retrieved over the network and distributed to the one or more software products executing on the client computer compatible with the corresponding extension.

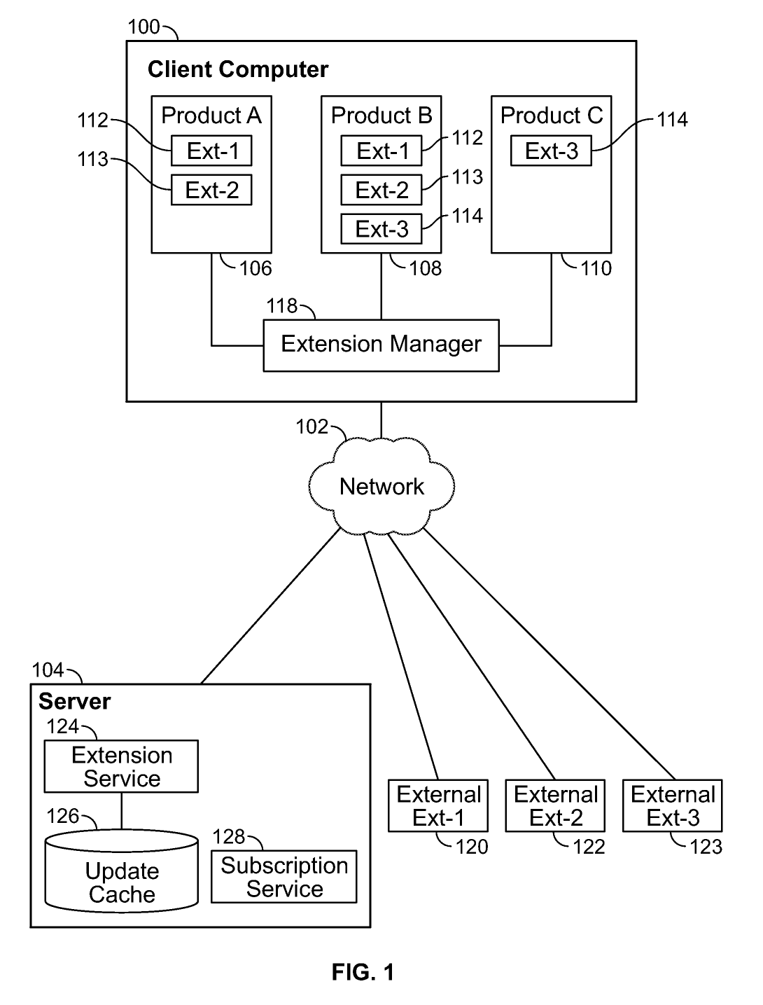

FIG. 1 is a schematic block diagram showing a system including an example client computer 100 connected for data communication by a network 102 to an example server 104. Three software products are installed on the client computer 100, namely, Product A 106, Product B 108 and Product C 110. In this illustrative example, Product A 106 includes two extensions, namely, Ext-1 112 and Ext-2 113. The extensions 112 and 113 were retrieved from a source external to the client computer 100. For example, the extensions 112 and 114 may have shipped with Product A. Alternatively, the extensions 112 and 113 may have been downloaded over the network 102 to the client computer 100. Product B 108 includes three extensions, that is, Ext-1 112, Ext-2 113 and Ext-3 114. Product C 110 includes one extension, that is, Ext-3 114.

There are at least three different types of extensions. First, some extensions are deliverable over the network 106 but do not require a network connection to execute full functionality. That is, once installed on the client computer 100, the extensions can provide full functionality by executing locally. Second, some extensions are deliverable over the network 106 and do require a network connection to execute any functionality. For example, these extensions execute in conjunction with an external web service. Third, some extensions are deliverable over the network 106 and can execute partial functionality locally on the client computer 100 without a network connection, but do require a network connection to provide full functionality. Kuler is an example of this type of extension. Kuler can be executed locally on a client computer to provide some functionality, e.g., creating color palettes, but requires a network connection to provide full functionality, e.g., to share created color palettes with other clients executing Kuler.

Referring again to Product A 106, each of Ext-1 112 and Ext-2 113 includes a user interface to integrate the extension with Product A 106. The user interface executes locally on the client computer 100. If either Ext-1 or Ext-2 requires a network connection to interact with an external web service, i.e., External-Ext-1 120 or External-Ext-2 122 respectively, to provide some or all of the functionality of the particular extension, then the extension's user interface in Product A is configured to provide a user of Product A interactivity with the external web service. In one implementation, an extension's user interface is implemented with a Flash panel and one or more script files.

An extension manager 118 is installed on the client computer 100. The extension manager 118 provides infrastructure to manage retrieval and delivery of updates to the extensions 112-114. The extension manager 118 is configured to automatically go to the network 102 to look for updates, to deliver updates to the client computer 100 and to distribute the updates to the software products with which they are compatible. In one implementation, the client computer 100 must have first used a particular extension before the extension manager 118 will initiate automatic updates. That is, if an extension is never used by the client computer 100, the extension manager 118 does not bother to keep the extension updated. In some implementations, a triggering event can initiate an automatic update. For example, a user of the client computer can request that an extension be updated. In another example, the first time the extension is used by the client computer 100 can trigger the extension manager 118 to search for updates.

In the example system shown, an extension service 124 is included in a server 104 that can be accessed by the client computer 100 over the network 102. In this implementation, the extension manager 118 in the client computer 100 periodically, or in response to a triggering event, determines what versions of each extension being updated is currently installed on the client computer 100. Information specifying a version is referred to as the “version information” for an extension. In some implementations, the extension service 124 provides information about all extensions that are available to the user and the corresponding current versions. The extension manager 118 uses the version information to determine the differences (if any) between the current versions and the locally available extensions, and thereby determines if updates are available.

In other implementations, the extension manager 118 provides the version information to the extension service 124. The extension service 124 compares the version information to current versions of the corresponding extensions and thereby determines if updates are available (i.e., newer versions than indicated in the version information).

In the implementation shown, an update cache 126 is included in the server 104. In another implementation, the update cache 126 can be external to the server 104, but accessible by the server 104, e.g., over the network 102 or otherwise. The update cache 126 can include complete current versions of a set of extensions, including extensions 112-114 and possibly others, a base version and all subsequent updates, just updates, or some combination thereof. In other implementations, the update cache 126 does not include the updates, but includes information about where to obtain the updates, e.g., a URL address or a link to an external web service corresponding to the extension. For example, an update to Ext-1 112 may be available from the external web service External Ext-1 120.

The extension service 124 obtains the updates required by the client computer based on the version information provided by the extension manager 118 and provides the updates to the extension manager 118 over the network 102. The extension manager 118 distributes the updates to the software products installed on the client computer 100 that are compatible with the extension corresponding to the update. For example, an update can include metadata that identifies software products that the corresponding extension is compatible with, and the extension manager 118 can use the metadata to properly distribute the updates.

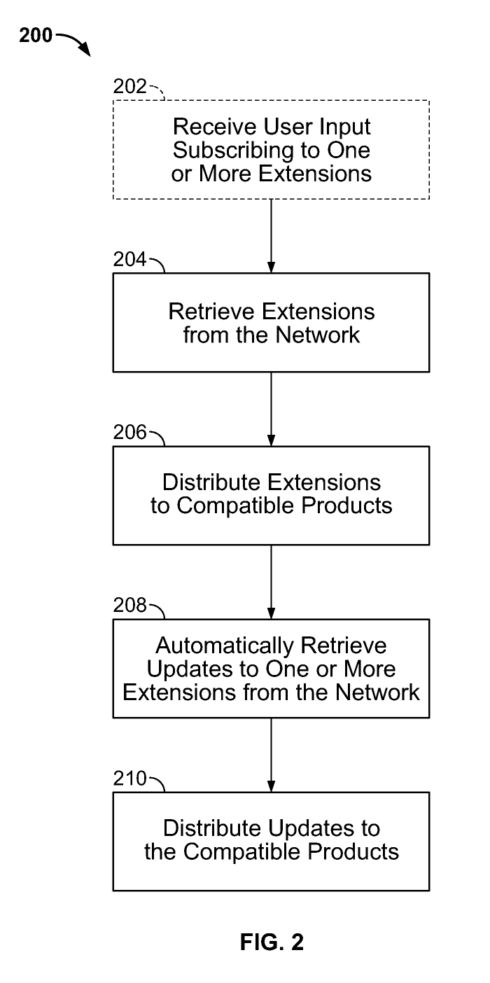

FIG. 2 is a flowchart that illustrates a method 200 for delivering extensions and updates to a client computer. In one implementation of the method 200, an optional step includes receiving a user input subscribing to one or more extensions (step 202). For example, a user of the client computer can select from a set of available extensions the one or more extensions that the user would like to integrate with one or more software products installed on the client computer. In some implementations, a fee is charged for each extension subscribed to by the user, the fee being, for example, either a lump sum and/or periodic payment. Optionally, a subset of extensions can be packaged together and made available as a bundle.

As shown in FIG. 1, in one implementation, a subscription service 128 on the server 104 interacts with the user to receive the user input subscribing to one or more extensions. For example, the subscription service 128 can be implemented with a web page user interface that a user can use over the Internet or other network 102. The user can interact with the web page to subscribe to one or more extensions. In other implementations, the subscription service 128 can be implemented separate from the server 104. In other implementations, the user input can be received by the extension manager 118 on the client computer 100. The extension manager 118 can transmit the subscription request to the subscription service 128. In yet another implementation, the subscription service 128 can be included on the client computer, for example, as part of the extension manager 118. Preferably though the subscription service 128 is external to the client computer 100, such that a centralized subscription database, for example, that applies to multiple users can be provided.

Once the user of the client computer has subscribed to one or more extensions, the client computer retrieves the extensions from a source over the network to (step 204). For example, if implementing the method 200 using the system shown in FIG. 1, the subscription service 128 (wherever located depending on the implementation) can notify the extension manager 118 that one or more particular extensions were subscribed to by the user of the client computer 100. The extension manager 118 can retrieve the extensions over the network 102. For example, if the user subscribed to Ext-1, Ext-2 and Ext-3 (i.e., extensions 112-114), the extension manager 118 can retrieve these extensions 112-114 over the network 102 from their corresponding external web service, i.e., External-Ext-1 120, External-Ext-2 122 and External-Ext-3 123. In another implementation, current versions of the extensions can be retrieved directly from the server 104, for example, from the update cache 126.

The retrieved extensions are automatically distributed to software products installed on the client computer that are compatible with the extensions (step 206). For example, metadata included in an extension can be used to determine what software products the extension is compatible with, and the extension can then be distributed to any such software products installed on the client computer.

For illustrative purposes, if the method 200 is implemented using the system shown in FIG. 1, the extension manager 118, which retrieved the extensions, can then distribute the extensions to the compatible software products. For example, Ext-1 112 is distributed to Product A 106 and Product B 108. By way of illustrative example, Ext-1 112 is implemented with a Flash Panel (SWF) and script files. The extension manager 118 can provide Product A 106 and Product B 108 a URL or path of the Ext-1's SWF and script files. Product A 106 and Product B 108 can use this information to open up a panel containing the SWF when a user of the client computer 100 selects to interact with Ext-1 (e.g., by clicking on a corresponding menu item displayed on a user interface). In some implementations, the SWF is the same for Product A 106 and Product B 108, although the script files can be different. In other implementations, for the particular extension, e.g., Ext-1, the SWF and script files can be different, depending on the product the extension is being integrated into.

Updates to the extensions are automatically retrieved from the network (step 208). The updates are distributed to the compatible software products (step 210). For example, if an update to Ext-1 112 is available, then rather than wait until host Product A 106 is updated, Ext-1 112 can be updated separately on its own. Additionally, the updating can occur automatically, without requiring user interaction, although the user can initiate the update or initiate a triggering event (e.g., using Ext-1 for the first time). The extension manager 118 can retrieve the updates and distribute them to the compatible products. For example, an update to Ext-3 114 is retrieved and distributed to Product B 108 and Product C 110.

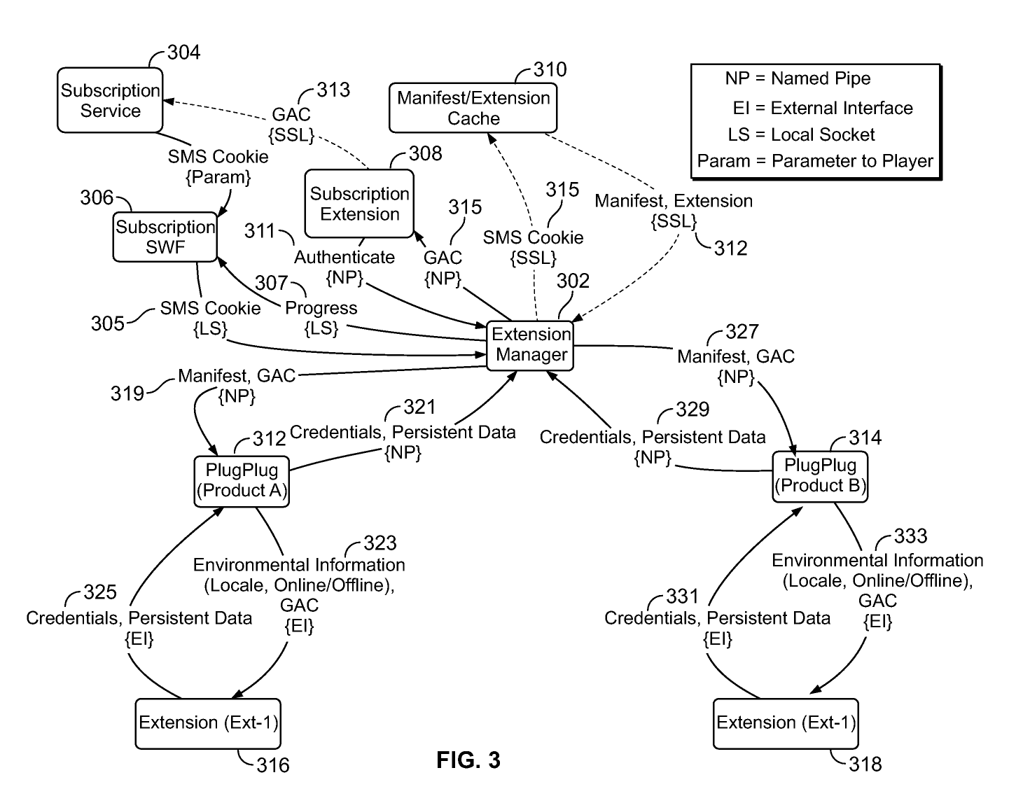

FIG. 3 shows an example data flow diagram for delivering and updating extensions. In this implementation, a Subscription Service 304 is implemented using a Subscription SWF (i.e., a Flash panel) 306. A user of a client computer on which the Extension Manager 302 is executing interacts with the Subscription SWF 306 to indicate his/her subscription selection. In the example data flow shown, the user has subscribed to an extension named “Ext-1”. The Extension Manager 302 can receive an SMS Cookie 305 from the Subscription SWF 306 that communicates information the Extension Manager 302 can use to check for extensions and updates for the user, based on his/her subscription selection. In one example the information includes a URL. Upon receipt of the SMS Cookie 305, the Extension Manager 302 retrieves Ext-1 and looks for available updates to Ext-1. The Extension Manager 302 can report progress 307 of this retrieval back to the Subscription SWF. In some implementations, progress of the extension and update retrieval is displayed on a user interface for the user.

In the implementation shown, a Subscription Extension 308 provides log-in functionality, such that the user can enter log-in information before being permitted to subscribe to one or more extensions. The Subscription Extension 308 passes the Authenticate 311 information received from the user (e.g., log-in information) to the Extension Manager 302. The Extension Manager 302 passes a GAC (“Global Authentication Cookie”) 309 back to the Subscription Extension 308, where a GAC is a response generated by a backend component that a front end component passes to indicate that a user is authenticated and in order for the backend to know the identity of the user connecting.

The Extension Manager 302 passes an SMS Cookie 315 to a Manifest/Extension Cache 310 requesting the extension subscribed to, i.e., Ext-1, and any available updates. In this implementation, in response, the Extension Manager 302 receives a Manifest and Extension 317 that includes information about the extensions that are available to the particular user (e.g., Ext-1), the extensions most current versions and where to obtain them. The Extension Manager 302 uses the information to determine if there are any updates or additional extensions available to the user and, if so, obtains and downloads them to the client computer.

In this example, Ext-1 is compatible with Product A and Product B. Each of Product A and Product B includes an integrated library, shown on the diagram as PlugPlug 312 and PlugPlug 314 for the Products A and B respectively. PlugPlug asks the Extension Manager 302 for a Manifest. For example, PlugPlug 312 for Product A asks for and receives Manifest 319 from the Extension Manager 302. The Manifest 319 is metadata describing all the extensions that are currently available on the client computer. PlugPlug 312 uses this information to add any missing extensions that are compatible with Product A to Product A. By way of illustrative example, PlugPlug 312 may add a menu item that can be used to access Ext-1, may add other user interface elements, such as buttons in a toolbar, etc., to access Ext-1 functionality, and/or may register for certain events that Product A might be broadcasting, e.g., file open, file close, etc.

The Manifest 319 can also include information about the language the extension is available in and other metadata about the extensions. The Manifest 319 includes information about where on the client computer to obtain the extensions. That is, the Manifest 319 can include a URL (e.g., if the SWF and script files are available through a locally running server) or path of an extension's SWF and script files, as an example. In the particular example shown, the Manifest 319 includes information about where to obtain the SWF and script files for Ext-1 316. When a user of Product A selects to use Ext-1, e.g., by clicking on a corresponding menu entry in a Product A user interface, PlugPlug 312 uses the Manifest 319 information to display an Ext-1 user interface, e.g., a Flash panel containing the SWF.

Similarly, PlugPlug 314 corresponding to Product B passes and receives similar information in order to provide Ext-1 integrated into Product B. In some implementations, Ext-1 integrates into Products A and B with the same user interface, although the script files may be different. In other implementations, Ext-1 integrates into Products A and B with different user interfaces.

In some implementations, there is only one copy of a specific version of a SWF for an extension, e.g., Ext-1, on the client computer. Both Products A and B share the SWF. The script files though, as mentioned above, can be product specific. Also, there can be different SWFs/Scripts depending on the locale. For example, an extension can provide a different SWF for different languages. A Hebrew version of the user interface may look different than an English version in order to better support the right-to-left nature of the Hebrew language. If an update to Ext-1 becomes available, the Extension Manager 302 downloads the updated Ext-1, making it available under a different location then the previous version. It is possible that Product A may then use a different versions of the Ext-1 files, if Product B is still be running the old version, while Product A, started later already uses the new one.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

1. A method comprising:
retrieving to a client computer over a network one or more extensions from a source external to the client computer, where each extension comprises software that is configured to integrate with one or more software products installed on the client computer and includes a user interface to extend user interaction within the one or more software products;
distributing each extension to the one or more software products on the client computer;
upon determining that the one or more of the extensions have been used by the client computer at least once, automatically retrieving over the network updates corresponding to the one or more extensions, wherein automatically retrieving the updates comprises:
determining version information for each of the one or more extensions retrieved, and
providing the version information over the network to an extension service; and
distributing each update to the one or more software products executing on the client computer compatible with the corresponding extension.

2. The method of claim 1, wherein retrieving over the network the one or more extensions is in response to a user input subscribing to the one or more extensions.

3. The method of claim 1, wherein at least one of the one or more extensions comprises software requiring a network connection to execute full functionality on the client computer.

4. The method of claim 1, wherein at least one of the one or more extensions comprises software executable on the client computer without a network connection.

5. The method of claim 1, wherein at least one of the one or more extensions comprises software executable on the client computer without a network connection to provide partial functionality and with a network connection to provide full functionality.

6. (canceled)

7. The method of claim 1, further comprising:
periodically determining whether an update for each of the one or more extensions exists;
wherein automatically retrieving over the network updates corresponding to the one or more extensions is in response to determining an update for each of the one or more extensions exists.

8. A method comprising:
determining version information for one or more extensions hosted by one or more software products installed on a client computer, where the version information specifies a version of the extension and where each extension comprises software that is configured to integrate with the one or more host software products and includes a user interface to extend user interaction within the one or more software products;
upon determining that the one or more extensions have been used by the client computer at least once, providing the version information over a network to an extension service, and obtaining updates available for the one or more extensions based on the version information; and
distributing the updates to the one or more extensions to the one or more software products compatible with the corresponding extensions.

9. (canceled)

10. The method of claim 8, further comprising:
periodically determining if updates are available;
wherein obtaining updates is in response to determining updates are available.

11. A machine readable storage device encoded with a computer program product operable to cause data processing apparatus to perform operations comprising:
retrieving to a client computer over a network one or more extensions from a source external to the client computer, where each extension comprises software that is configured to integrate with one or more software products installed on the client computer and includes a user interface to extend user interaction within the one or more software products;
distributing each extension to the one or more software products on the client computer;
upon determining that the one or more of the extensions have been used by the client computer at least once, automatically retrieving over the network updates corresponding to the one or more extensions, wherein automatically retrieving the updates comprises:
determining version information for each of the one or more extensions retrieved, and
providing the version information over the network to an extension service; and
distributing each update to the one or more software products executing on the client computer compatible with the corresponding extension.

12. The machine readable storage device of claim 11, wherein retrieving over the network the one or more extensions is in response to a user input subscribing to the one or more extensions.

13. The machine readable storage device of claim 11, wherein at least one of the one or more extensions comprises software requiring a network connection to execute full functionality on the client computer.

14. The machine readable storage device of claim 11, wherein at least one of the one or more extensions comprises software executable on the client computer without a network connection.

15. The machine readable storage device of claim 11, wherein at least one of the one or more extensions comprises software executable on the client computer without a network connection to provide partial functionality and with a network connection to provide full functionality.

16. (canceled)

17. The machine readable storage device of claim 11, where the computer program product is further operable to cause data processing apparatus to perform operations comprising:
periodically determining whether an update for each of the one or more extensions exists;
wherein automatically retrieving over the network updates corresponding to the one or more extensions is in response to determining an update for each of the one or more extensions exists.

18. A machine readable storage device encoded with a computer program product operable to cause data processing apparatus to perform operations comprising:
determining version information for one or more extensions hosted by one or more software products installed on a client computer, where version information specifies a version of the extension and where each extension comprises software that is configured to integrate with the one or more host software products and includes a user interface to extend user interaction within the one or more software products;
upon determining that the one or more extensions have been used by the client computer at least once, providing the version information over a network to an extension service, and obtaining updates available for the one or more extensions based on the version information; and
distributing the updates to the one or more extensions to the one or more software products compatible with the corresponding extensions.

19. (canceled)

20. The machine readable storage device of claim 18, where the computer program product is further operable to cause data processing apparatus to perform operations comprising:
periodically determining if updates are available;
wherein obtaining updates is in response to determining updates are available.

21. A system comprising:
a processor;
a storage device coupled to the processor and configurable for storing instructions, which, when executed by the processor, cause the processor to perform operations comprising:
retrieving to a client computer over a network one or more extensions from a source external to the client computer, where each extension comprises software that is configured to integrate with one or more software products installed on the client computer and includes a user interface to extend user interaction within the one or more software products;
distributing each extension to the one or more software products on the client computer;
upon determining that the one or more of the extensions have been used by the client computer at least once, automatically retrieving over the network updates corresponding to the one or more extensions, wherein automatically retrieving the updates comprises:
determining version information for each of the one or more extensions retrieved, and
providing the version information over the network to an extension service; and
distributing each update to the one or more software products executing on the client computer compatible with the corresponding extension.

22. The system of claim 21, wherein retrieving over the network the one or more extensions is in response to a user input subscribing to the one or more extensions.

23. The system of claim 21, wherein at least one of the one or more extensions comprises software requiring a network connection to execute full functionality on the client computer.

24. The system of claim 21, wherein at least one of the one or more extensions comprises software executable on the client computer without a network connection.

25. The system of claim 21, wherein at least one of the one or more extensions comprises software executable on the client computer without a network connection to provide partial functionality and with a network connection to provide full functionality.

26. (canceled)

27. The system of claim 21, wherein the storage device is further configurable for storing instructions which, when executed by the processor, cause the processor to perform operations comprising:
periodically determining whether an update for each of the one or more extensions exists;
wherein automatically retrieving over the network updates corresponding to the one or more extensions is in response to determining an update for each of the one or more extensions exists.

28. A system comprising:
a processor;
a storage device coupled to the processor and configurable for storing instructions, which, when executed by the processor, cause the processor to perform operations comprising:
determining version information for one or more extensions hosted by one or more software products installed on a client computer, where version information specifies a version of the extension and where each extension comprises software that is configured to integrate with the one or more host software products and includes a user interface to extend user interaction within the one or more software products;
upon determining that the one or more extensions have been used by the client computer at least once, providing the version information over a network to an extension service, and obtaining updates available for the one or more extensions based on the version information; and
distributing the updates to the one or more extensions to the one or more software products compatible with the corresponding extensions.

29. (canceled)

30. The system of claim 28, wherein the storage device is further configurable for storing instructions which, when executed by the processor, cause the processor to perform operations comprising:
periodically determining if updates are available;
wherein obtaining updates is in response to determining updates are available.

31. A system comprising:
a client computer including:
one or more software products installed on the client computer;
an extension manager configured to:
retrieve one or more extensions over a network and to distribute the one or more extensions to one or more of the software products compatible with the extensions, and
upon determining that the one or more of the extensions have been used by the client computer at least once, automatically retrieve updates to the one or more extensions over a network and to distribute the updates to the one or more software products compatible with the extensions corresponding to the updates;
the one or more extensions, where each extension comprises software that is configured to integrate with the one or more compatible software products and includes a user interface to extend user interaction within the one or more compatible software products; and
a server including:
an extension service configured to:
provide information to the extension manager based at least in part upon version information for each of the one or more retrieved extensions as provided by the extension manager, wherein the information provided to the extension manager can be used to retrieve the updates to the one or more extensions.

32. The system of claim 31, wherein the server further includes:
an update cache including information based on which the extension manager can retrieve the updates to the one or more extensions.

33. The system of claim 31, wherein the server further includes:
a subscription service configured to:
receive input from a user of the client computer subscribing to the one more extensions;
wherein, in response to the received input, the information based on which the extension manager can retrieve the one or more extensions is provided to the extension manager.
